(19) United States
(12) Patent Application Publication
(10) Pub. No.: US 2016/0167451 A1
(43) Pub. Date: Jun. 16, 2016

(54) RIM/TIRE INTERFACE STRUCTURE

(71) Applicant: The Goodyear Tire & Rubber Company, Akron, OH (US)

(72) Inventors: Phaniraj Muthigi, Copley, OH (US); Aruna Mani Velamakanni, Copley, OH (US); Derek Shuttleworth, Medina, OH (US); David Ray Hubbell, Hartville, OH (US); James Gregory Gillick, Akron, OH (US)

(21) Appl. No.: 14/591,973

(22) Filed: Jan. 8, 2015

Related U.S. Application Data
(60) Provisional application No. 62/091,103, filed on Dec. 12, 2014.

(51) Int. Cl. B60C 15/02; B60C 9/18

(52) U.S. Cl. CPC B60C 15/0209; B60C 9/18

(57) ABSTRACT

A pneumatic tire includes a pair of annular beads, at least one carcass ply wrapped around the beads, a tread disposed over the carcass ply in a crown area of the pneumatic tire, and sidewalls disposed radially between the tread and the beads. The pneumatic tire is mounted on a rim and a contact area of the pneumatic tire with the rim has carbon nanotubes for reducing micro-slippage between the beads and the rim during rotation of the pneumatic tire under load.

### TECHNICAL FIELD

The present invention relates to a pneumatic tire and method for designing a pneumatic tire.

### BACKGROUND ART

In conventional bias ply tires, the opposed angles of the reinforcement cords in adjacent carcass plies have caused the carcass plies to work against each other, and this construction caused the bias ply tire to act as a unit. That is, stresses encountered by the tire while rolling on a vehicle were distributed throughout the tire. The belt or breaker package in the tire provided a constraint to stiffen the tire and reduce its deformation, and provided a base for a flattened tread against the road.

With the advent of the radial ply tire, the high angles of the reinforcement cords in the carcass plies, relative to the equatorial plane (EP) of the tire, reduced the interaction between the carcass plies and increased the flexibility of the sidewalls. The increased flexibility in the sidewalls reduced stresses on the crown and tread area of the tire since most of the energy absorbed by the tire while running on a vehicle was absorbed by the sidewalls.

One conventional low-profile pneumatic radial tire is manufactured by using a green tire built in a first and a second building step, wherein an uncured inner sidewall rubber segment and an uncured outer sidewall rubber segment are separately provided to correspond to an inner portion and an outer portion, and parted from each sidewall rubber of a tire, after vulcanization. The components are provided in a radial direction in the tire, providing a parting face located on an outer surface of the sidewall rubber which is not more than one half of a section height of the tire. The uncured inner sidewall rubber segment is attached in the first building step and the uncured outer sidewall rubber segment is attached at the second building step. This construction may have excellent resistance to cracking in the sidewall portion without degrading tire performance.

Another conventional tire may include a body ply reinforcement, a top ply reinforcement, and a tire tread joined to two tire beads via two sidewalls. The axially outer edges of the tire tread are folded down over the radially outer ends of the sidewalls. A tire made using a “flat belt concept” has a flatter contour which increases the contact area on the road's surface, and reduces the flexing of the tire. A tire may have an axially outer bead tip that may divorce the bead from the sidewall of the tire, the bead acting as a fulcrum to convert outward tension for tire retention.

A method of building a tire may provide unequal bead diameters where the two sidewalls of the tire have different profiles in the mold. A method of making a pneumatic tire may cure the tire in a mold with a curved configuration having the same tread radius in the center, and an increased tread radius at the margins of the tread. A tire may have multiple radii in the mold shape.

### SUMMARY OF THE INVENTION

A pneumatic tire in accordance with the present invention comprises a pair of annular beads, at least one carcass ply wrapped around the beads, a tread disposed over the carcass ply in a crown area of the pneumatic tire, and sidewalls disposed radially between the tread and the beads. The pneumatic tire is mounted on a rim and a contact area of the pneumatic tire with the rim has carbon nanotubes for reducing micro-slippage between the beads and the rim during rotation of the pneumatic tire under load.

According to another aspect of the pneumatic tire, the tread is flat with respect to a surface on which the pneumatic tire is in contact.

According to still another aspect of the pneumatic tire, reinforcement belts are interposed between the carcass ply and the tread in the crown area. The reinforcement belts are anchored in a shoulder region of the pneumatic tire thereby providing hinged support for the tread and a decoupling of the tread from the upper sidewall. The shoulder is defined as the intersection of a ply line radius and a tread radius.

According to yet another aspect of the pneumatic tire, a rhoₘ is higher on the pneumatic tire than 50% of a section height of the pneumatic tire.

According to still another aspect of the pneumatic tire, a rhoₘ is 55% to 65% of a section height of the pneumatic tire.

According to yet another aspect of the pneumatic tire, a shoulder, 50% of a section height, and the bead define points on a circle and a shoulder radius of the pneumatic tire is smaller than a radius of the circle.

According to still another aspect of the pneumatic tire, a shoulder, 50% of a section height, and the bead define points on a reference circle and a shoulder radius of the pneumatic tire is 50% to 60% of a radius reference of circle.

According to yet another aspect of the pneumatic tire, lower portions of the sidewalls have a concave profile.

According to still another aspect of the pneumatic tire, a molded base width is 20% to 25% wider than a specification rim width for the pneumatic tire.

According to yet another aspect of the pneumatic tire, turn-up ply endings extend at least to 35% of a section height of the pneumatic tire.

According to still another aspect of the pneumatic tire, an apex extends at least 20% of a section height of the pneumatic tire.

A method in accordance with the present invention assembles a pneumatic tire onto a rim. The method includes the step of orienting carbon nanotubes adjacent a contact surface of the rim such that each carbon nanotube extends perpendicularly to its individual contact point on the rim thereby reducing micro-slippage between the pneumatic tire and the rim during rotation of the pneumatic tire under load.

### Definitions

“Apex” refers to a wedge of rubber placed between the carcass and the carcass turnup in the bead area of the tire, usually used to stiffen the lower sidewall of the tire.

“Axial” and “axially” means lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt reinforcing structure” means at least two layers of plies of parallel cords, woven or unwoven, underlying the tread, unanchored to the bead, and having both left and right cord angles in the range from 17 degrees to 27 degrees with respect to the equatorial plane of the tire.

“Bias ply tire” means a tire having a carcass with reinforcing cords in the carcass ply extending diagonally across the tire from bead core to bead core at about a 25 to 50 degree angle with respect to the equatorial plane of the tire. Cords run at opposite angles in alternate layers.

“Breakers” refers to at least two annular layers or plies of parallel reinforcement cords having the same angle with reference to the equatorial plane of the tire as the parallel reinforcing cords in carcass plies.

“Carcass ply” means the tire structure apart from the belt structure, tread, undertread, sidewall rubber and the beads.

“Chafers” refers to narrow strips of material placed around the outside of the bead to protect cord plies from the rim, distribute flexing above the rim, and to seal the tire.

“Cord” means one of the reinforcement strands of which the plies in the tire are comprised.

“Design rim” means a rim having a specified configuration and width. For the purposes of this specification, the design rim and design rim width are as specified by the industry standards in effect in the location in which the tire is made. For example, in the United States, the design rims are as specified by the Tire and Rim Association. In Europe, the rims are as specified in the European Tyre and Rim Technical Organization—Standards Manual and the term design rim means the same as the standard measurement rims. In Japan, the standard organization is The Japan Automobile Tire Manufacturer's Association.

“Design rim width” is the specific commercially available rim width assigned to each tire size and typically is between 75 and 90% of the specific tire's section width.

“Equatorial plane (EP)” means the plane perpendicular to the tire's axis of rotation and passing through the center of its tread.

“Filament” refers to a single yarn.

“Footprint” means the contact patch or area of contact of the tire tread with a flat surface at zero speed and under normal load and pressure.

“Innerliner” means the layer or layers of elastomer or other material that form the inside surface of a tubeless tire and that contain the inflating fluid within the tire.

“Lateral edge” means the axially outermost edge of the tread as defined by a plane parallel to the equatorial plane and intersecting the outer ends of the axially outermost traction lugs at the radial height of the inner tread surface.

“Leading” refers to a portion or part of the tread that contacts the ground first, with respect to a series of such parts or portions, during rotation of the tire in the direction of travel.

“Molded base width” refers to the distance between the beads of the tire in the curing mold. The cured tire, after removal from the curing mold will substantially retain its molded shape, and “molded base width” may also refer to the distance between the beads in an unmounted, cured tire.

“Net contact area” means the total area of ground contacting tread elements between the lateral edges.

“Nominal rim diameter” means the average diameter of the rim flange at the location where the bead portion of the tire seats.

“Normal inflation pressure” refers to the specific design inflation pressure and load assigned by the appropriate standards organization for the service condition for the tire.

“Normal load” refers to the specific design inflation pressure and load assigned by the appropriate standards organization for the service condition for the tire.

“Pantographing” refers to the shifting of the angles of cord reinforcement in a tire when the diameter of the tire changes, e.g. during the expansion of the tire in the mold.

“Ply” means a continuous layer of rubber-coated parallel cords.

“Pneumatic tire” means a mechanical device of generally toroidal shape (usually an open torus) having beads and a tread and made of rubber, chemicals, fabric and steel or other materials. When mounted on the wheel of a motor vehicle, the tire, through its tread, provides a traction and contains the fluid or gaseous matter, usually air, that sustains the vehicle load.

“Radial” and “radially” means directions radially toward or away from the axis of rotation of the tire.

“Radial-ply tire” means a belted or circumferentially restricted pneumatic tire in which the ply cords which extend from bead to bead are laid at cord angles between 65 to 90 degrees with respect to the equatorial plane of the tire.

“Rhoₘ” refers to the perpendicular distance from the axis of rotation of a tire to a line parallel to the axis of rotation which passes through the maximum section width of the tire.

“Section height” (SH) means the radial distance from the nominal rim diameter to the outer diameter of the tire at its equatorial plane.

“Section width” (SW) means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Shoulder” means the upper portion of a sidewall just below the tread edge.

“Sidewall” means that portion of a tire between the tread and the bead.

“Splice” refers to the connection of end of two components, or the two ends of the same component in a tire. “Splice” may refer to the abutment or the overlapping of two such ends.

“Strain energy density” refers to the summation of the product of the six stress components (three normal stresses and three shear stresses) and their corresponding strains.

“Tire design load” is the base or reference load assigned to a tire at a specific inflation pressure and service condition: other load-pressure relationships applicable to the tire are based upon that base or reference.

“Tread” means a molded rubber component which, when bonded to a tire casing, includes that portion of the tire which comes into contact with the road when the tire is normally inflated and under normal load.

“Tread arc width” (TAW) means the width of an arc having its center located on the plane (EP) and which substantially coincides with the radially outermost surfaces of the various traction elements (lugs, blocks, buttons, ribs, etc.) across the lateral or axial width of the tread portions of a tire when the tire is mounted upon its designated rim and inflated to its specified inflation pressure but not subjected to any load.

“Tread width” means the arc length of the tread surface in the axial direction, that is, in a plane passing through the axis of rotation of the tire.

“Unit tread pressure” means the radial load borne per unit area (square centimeter or square inch) of the tread surface when that area is in the footprint of the normally inflated and normally loaded tire.

“Wedge” refers to a tapered rubber insert, usually used to define individual curvature of a reinforcing component, e.g. at a belt edge.

### BRIEF DESCRIPTION OF DRAWINGS

The present invention will be described by way of example and with reference to the accompanying drawings, in which:

FIG. 1 schematically illustrates a pneumatic tire in accordance with the present invention.

FIG. 2 schematically illustrates structural components of the pneumatic tire of FIG. 1.

FIG. 3 schematically illustrates superimposed views of a mold shape and a mounted shape of the pneumatic tire of FIG. 1.

FIG. 4 schematically illustrates stresses observed on a mounted tire, under load, superimposed with its original mold shape.

FIG. 5 schematically illustrates various relative dimensions within the tire of FIG. 1.

FIG. 6 schematically illustrates another pneumatic tire for use with the present invention.

FIG. 7 schematically illustrates superimposed views of the mold shape and the mounted shape of the pneumatic tire of FIG. 6.

FIG. 8 schematically illustrates a pneumatic tire and method in accordance with the present invention.

FIG. 9 schematically illustrates the pneumatic tire of FIG. 8 under load.

### DETAILED DESCRIPTION OF EXAMPLES OF THE PRESENT INVENTION

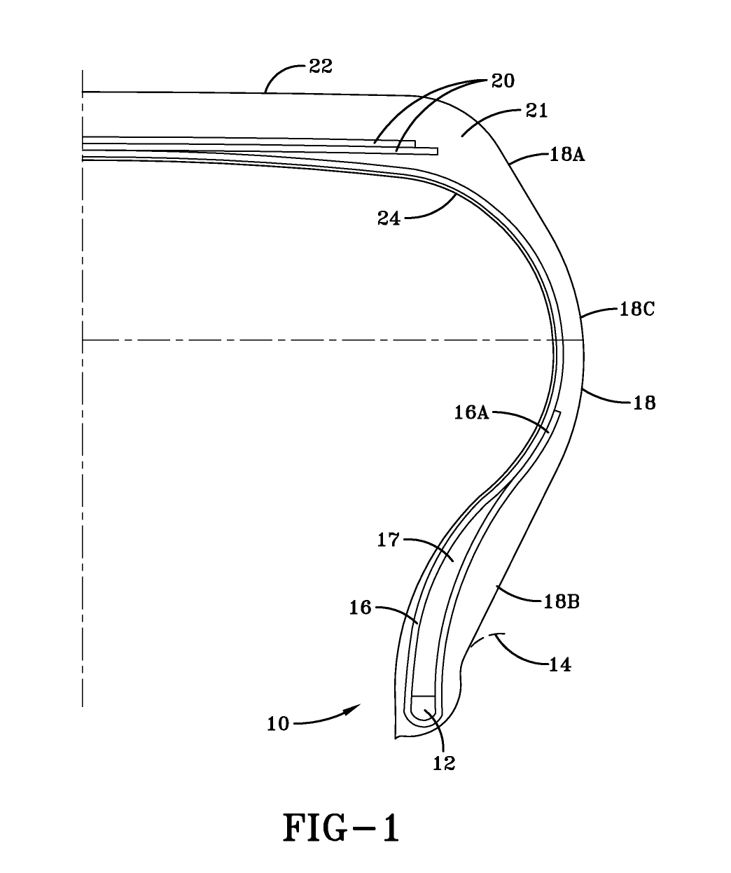

With reference now to FIG. 1, a pneumatic tire 10 for use with the present invention may include a pair of annular beads 12 around which are wrapped at least one carcass ply 16. Belts 20, in the crown area of the tire 10, may restrain the carcass ply 16 and reinforce the crown area of the tire. A tread 22 may be disposed radially outward of belts 20. Sidewalls 18 may be disposed between the tread 22 and the beads 12. Sidewalls 18 may include an upper sidewall 18a, which has a convex shape, and a lower sidewall 18b, which has a concave shape. The tire 10 may be mounted on a rim 14.

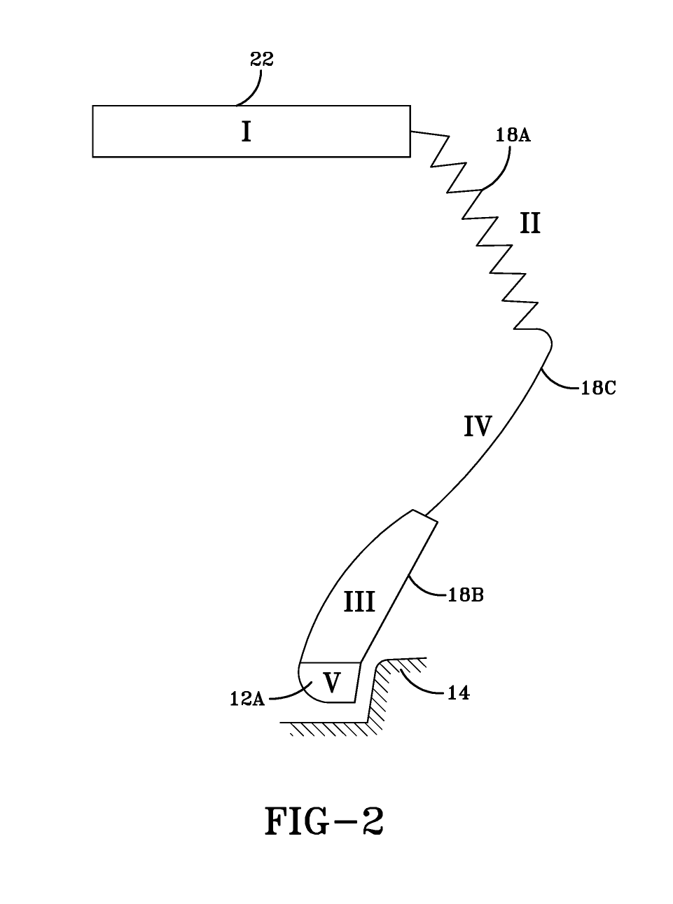

With reference now to FIG. 2, the tire 10 may be constructed such that a lower sidewall 18b is highly reinforced and is made with stiff compounds such that the lower sidewall is rigid and acts together with the bead portion 12a to form a supporting substructure with a specific shape. The bead portion 12a and lower sidewall 18b may act together when stresses act against the lower sidewall 18b such that the rim 14 acts as a pivot point for the movement of both the bead portion 12a and the lower sidewall 18b when the tire 10 is subjected to stress.

The lower sidewall portion 18b may have an apex 17 made of a stiff rubber with a modulus of 4760 Newtons per square centimeter (Npscm) to 6460 Npscm (7000 psi to 9500 psi) and a shape defined on one side by the ply line in the lower sidewall 18b, and on the opposite side, by a concave curve having a curvature equal to 0.5-0.8 times the curvature of the ply line in the lower sidewall 18b. The apex 17 may be 35% to 45% of the section height (SH) of the tire 10, and may be covered by the turnup portion 16a of carcass ply 16, which comprises at least 40%, but not more than 60%, of the section height of the tire. Finally, a chafer 19, which may be made of high modulus elastomer, and sidewall rubber 15, having a shape defined by a substantially flat exterior profile, may sandwich the apex 17, the turnup portion 16a, and the bead portion 12a to ensure that the lower sidewall portion 18b acts, within the dynamics of the tire 10, as an isolated, single tire component.

The upper sidewall 18a may be flexible so that it absorbs stresses encountered by the tread 22 and permitting the tread to remain substantially flat across the full tread width. The sidewall portion 18c may be less flexible than the sidewall portion 18a and less rigid than the sidewall portion 18b for providing a transition between the rigidity of the sidewall portion 18b and the flexibility of the sidewall portion 18a.

The tread 22 may have an increased axial stiffness and be further supported laterally by an extended wedge supporting the edges of the belts 20 and a laterally stiffened belt reinforcement. The belts 20 and tread 22 may accordingly act as a beam in the tire 10, which enhances the transfer of energy from the tread 22 to the upper sidewall portion 18a of the tire.

With reference again to FIG. 1, the belts 20 may have an extended width comprising 82% to 92% of the section width (SW) of the tire 10, may improve the rigidity of tread 22. A wedge 21 of rubber may be provided under the edges of the belts 20 to maintain the rigidity of tread 22. The wedge 21 may be made as an integrated, molded portion of the sidewall 18. The wedge 21 may be an “extended length” wedge, that is, the portion of wedge that is contiguous with the belts 20, may have a length that corresponds to 37% to 43% of the belt width. The wedge 21 may have a height that substantially removes all curvature from the belts 20 at the belt edge.

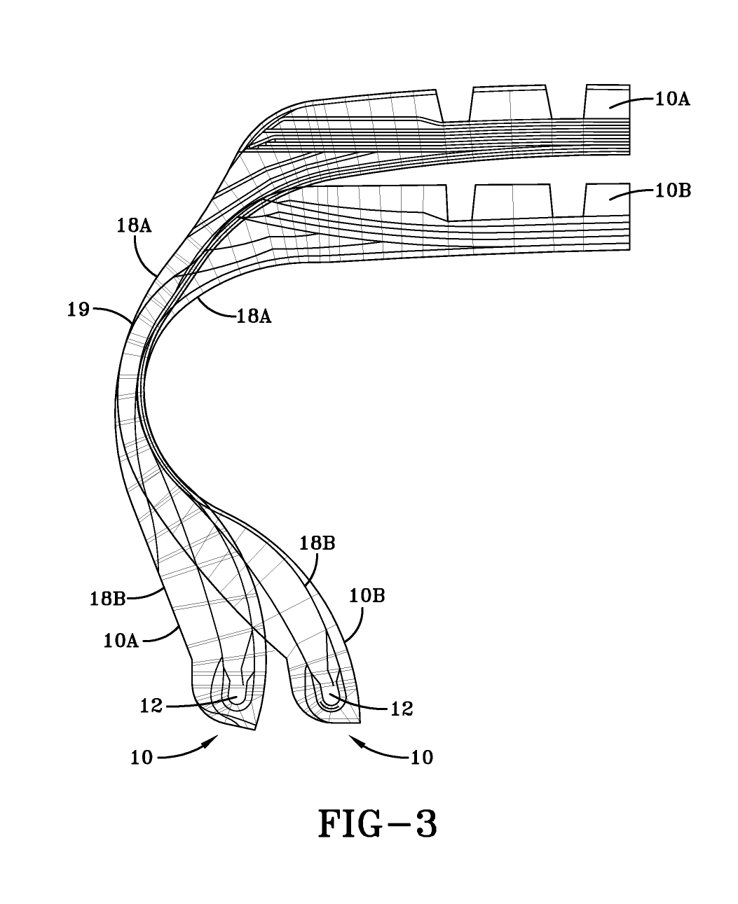

When a tire 10 is made, the tire components may be laid up to produce a green tire, and the green tire may be cured in a mold. The shape of a curing mold determines the cured shape of the tire 10. With reference now to FIG. 3, the tire 10 may be pre-stressed when mounted on its design rim 14. The tire 10 may have a molded shape 10a wherein the distance between beads 12 on opposed sides of the tire is wider than the distance between beads 12 of the tire mounted shape 10b when the tire is mounted on design rim 14, i.e., the distance between the bead seats in the mold is greater than the distance between the bead seats on the rim. FIG. 3 illustrates superimposed views of the molded shape 10a of the tire 10, and its shape 10b when it is mounted on the rim 14 and subjected to a normal load.

By pre-stressed, it is meant that stress is applied to parts of the tire 10 simply by the act of mounting the tire on the rim 14. Pre-stressing may provide more strength and durability to the tire 10, in much the same way that concrete is able to withstand greater impact when pre-stressed. The pre-stress may act to counter some of the stresses resulting from subsequent tire loads due to inflation and footprint load.

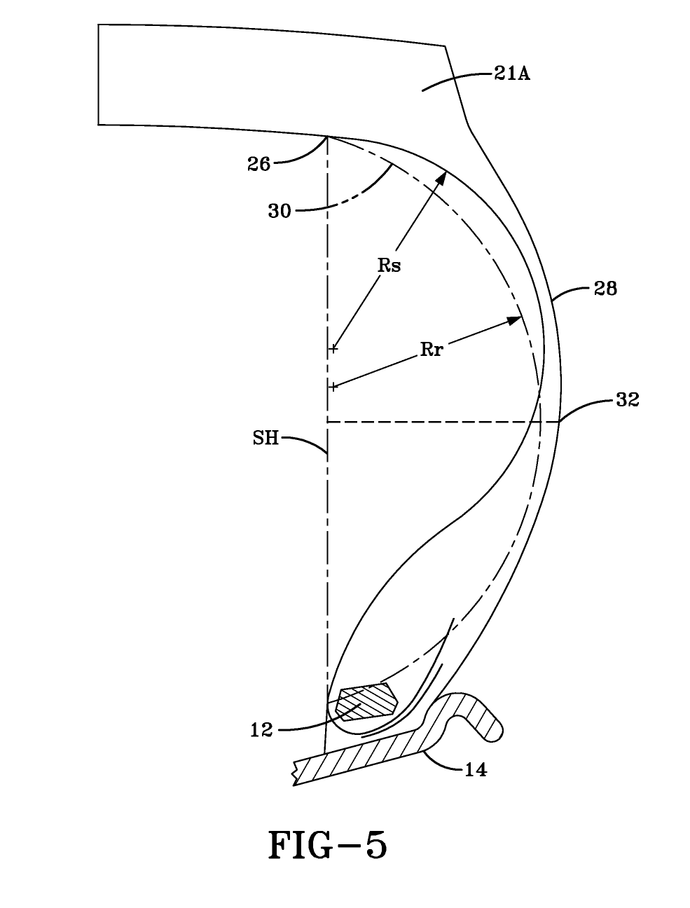

When the tire 10 with the mold shape 10a is mounted on the rim 14, because of the rigidity of lower sidewall 18b and the flexibility of upper sidewall 18a, the bead 12 and lower sidewall 18b may move in unison to accommodate the narrower rim width, and the sidewall may pivot at point 19 which is located in the upper sidewall 18a (FIG. 5). This pivot point 19 may further predispose the tire sidewall 18 to flex at this point thereby decoupling the tread 22 and upper sidewall portion 18a from the lower sidewall 18b.

Thus, the tread 22 may maintain flatter contact with a road surface. Flatter contact with the road means that the footprint of the tire 10 may remain substantially constant while the tire rotates and maximum possible net contact area may be maintained. Also, since the tread 22 does not distort laterally as the tire rotates, the tread does not work as much (i.e. there is less slipping and crawling), and the traction properties, wear properties, and rolling resistance properties may be improved.

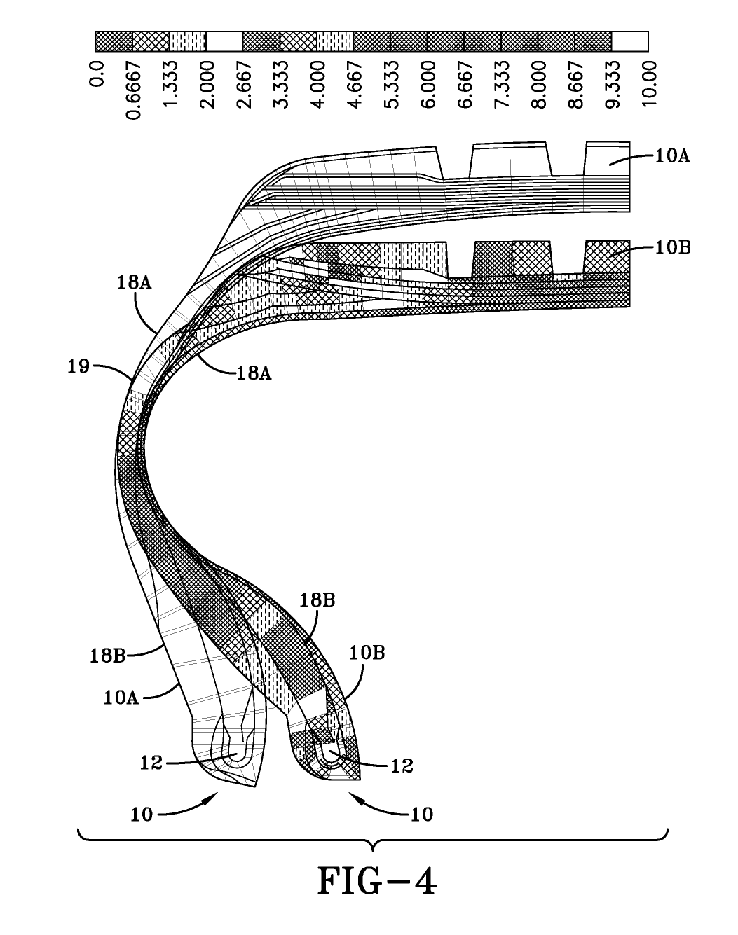

With reference now to FIG. 4, stresses in the pre-loaded tire 10 are illustrated. The shaded areas in the tire 10 may represent the areas of greatest stress. As can be seen in FIG. 3, the tire construction causes the stresses in the tire 10 to be directed to the mid to lower sidewall 18, the concave portion of the lower sidewall 18b, and the middle of the tread 22. These areas of the tire 10 may carry most of the load for the tire enhance steering response of the tire.

With reference now to FIG. 5, the tire 10 may have specific relationships between a shoulder point 26, a point 32 of the sidewall 18 which corresponds to 50% of the section height of the tire, and the bead 12. A reference circle 30 may be drawn containing the shoulder point 26, 50% of the section height 32, and the bead 12. The rhoₘ 28 of the tire 10, i.e., the widest point on the ply line of the tire, may be greater than 50% of the section height 32. A rhoₘ 28 of 7.7 cm (3.03 inches) may be selected corresponding to 60% of the section height 32. The radius Rᵣ of the reference circle 30 may be 6.22 cm (2.45 inches). The shoulder radius Rₛ of the ply line may be smaller than Rᵣ. When Rₛ is smaller than Rᵣ, a convex profile may be defined to induce flexural deformation and reduced shear deformations. Rₛ may be 40% to 70% of Rr. Alternatively, Rₛ may be about 55% of Rᵣ, which is 3.43 cm (1.35 inches).

By contrast, the lower sidewall portion 18b may have a concave profile, which may better withstand loads that are transferred from the footprint to the lower sidewall portion. The rigidity of tread 22, the flexibility of upper sidewall portion 18a, the convex shape of upper sidewall portion 18a, and the position of rhoₘ 28 may work together to transfer these loads to the lower sidewall portion 18b. The concave shape may also avoid stress reversals as a segment of the tire 10 moves in and out of the footprint. Such stress reversals may be detrimental to the durability of rubber and cord/rubber interfaces in the composite tire 10.

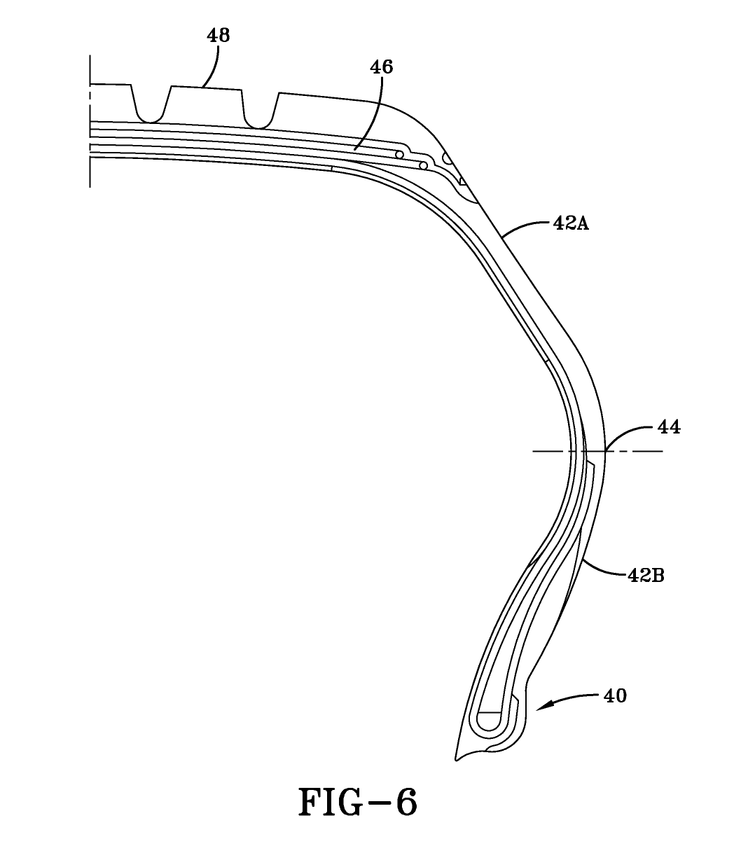

With reference now to FIG. 6, the upper sidewall portion 42a and lower sidewall portion 42b of a tire 40 may have a substantially straight shape. The widest point 44 in the tire sidewall 42 may correspond substantially with 50% of the section height of the tire 40. Belts 46 may be somewhat curved in the shoulder area of the tire 40 since a wedge may not be long enough to ensure a complete flattening of the belts.

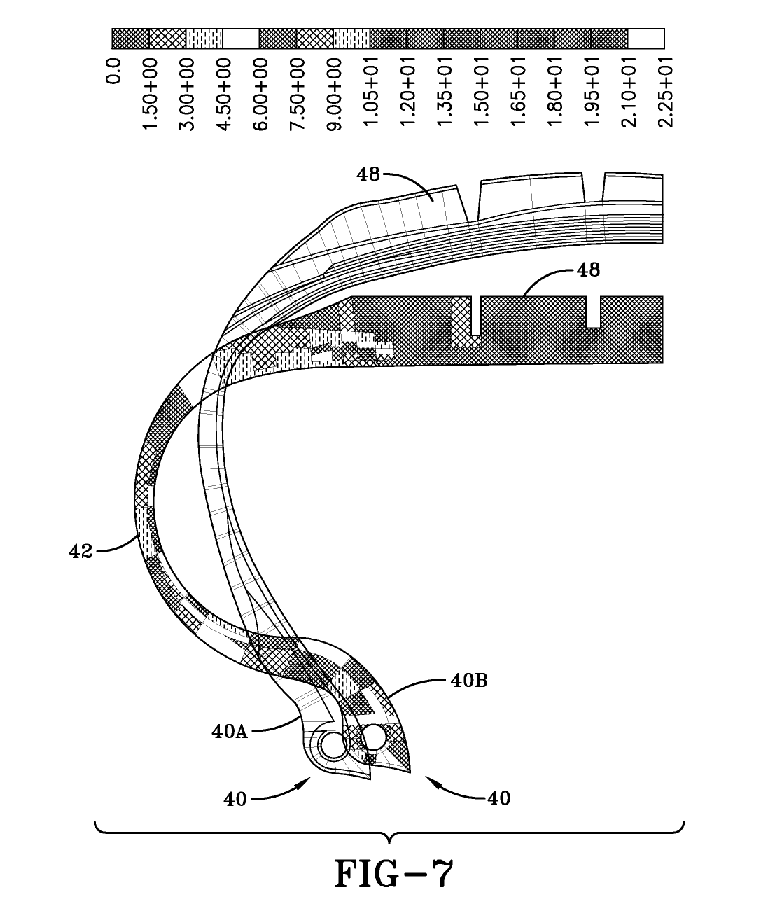

With reference now to FIG. 7, the mold shape 40a of the tire 40 may be substantially the same as the mounted shape 40b of the tire. Accordingly, the sidewall 42 may undergo a substantially uniform distortion throughout its length when the tire is mounted on its rim. The amount of distortion may only be modified by the thickness of the rubber in the various portions of the sidewall 42. Accordingly, there may be no pivot point in the sidewall 42 for distinguishing or isolating the movement of the tread 48 from the movement of the rest of the tire 40.

Thus, the design of the lower sidewall substructures of the tire 10 may result in (a) an internally convex carcass profile with a high point of contraflexure, (b) an apex that is stiff, as defined by its elastic modulus of 4760 Npscm to 6460 Npscm (7000 psi to 9500 psi), and extends above the carcass's point of contraflexure, (c) a turnup that extends above the apex and touches the carcass ply, and (d) a chipper compound defining an outer profile of the bead area of the tire, which together may provide the desired tire deformations first upon inflation and then upon footprint loading. The above structures and relationships have been described in U.S. Pat. No. 6,866,734, herein incorporated by reference in its entirety.

With the above principles in mind, poor bead anchorage and inefficient transfer of forces at the tire-rim interface have been linked to tire performance issues, such as steering performance loss (SPL), bead rocking, and/or vibrations. Measurements at the rim flange have shown that only 25% of cornering forces are transferred to the rim by contact pressure and most of the cornering forces (75%) are then transferred to the rim flanges by friction, or shear. For maximum force transmission, micro-slippage between chafer/toeguard in contact with the rim flange should be mitigated or eliminated to achieve better distribution of the contact pressure across the whole rim flange.

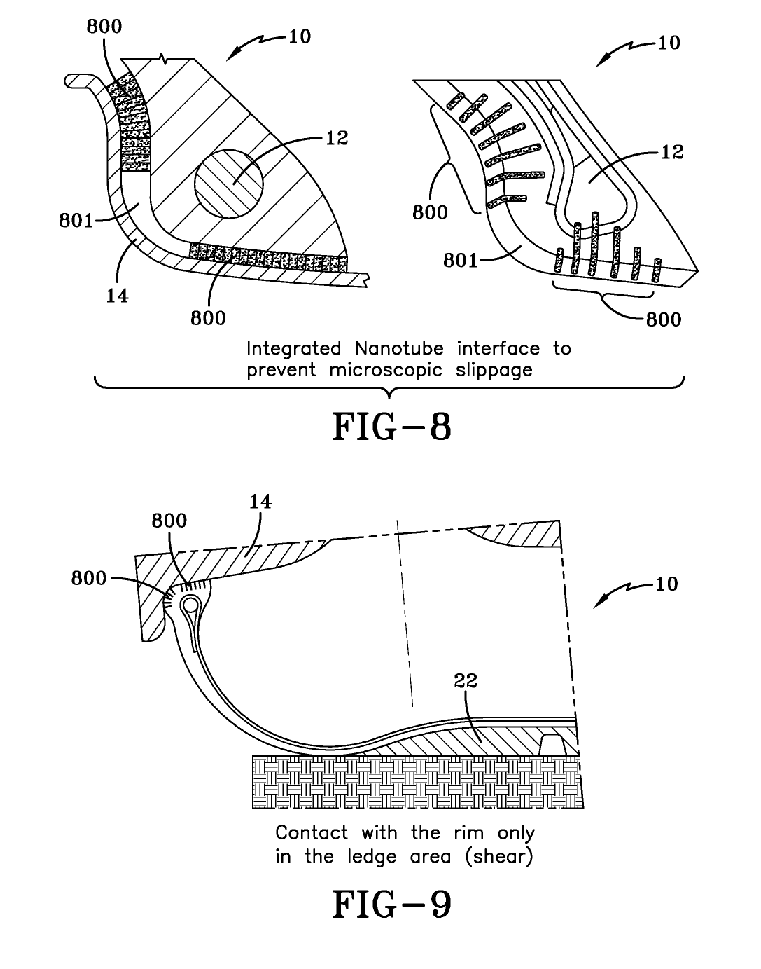

In accordance with the present invention, carbon nano-tubes 800 may be used to develop a toeguard/chafer nanoskin 801 with superior surface characteristics to achieve molecular level anchorage to the rim flange 14 (FIGS. 8 & 9). Conventionally, bead anchorage has been degraded by surface contaminants Laser cleaning, increasing compound stiffness, and/or compound frictional characteristics have been conventional methods for improving bead anchorage, but trade-offs have degraded other performance characteristics.

A method in accordance with the present invention (FIGS. 8 & 9) may use carbon nano tubes 800 oriented perpendicularly to the rim contact surface 14 at surfaces experiencing high shear force to achieve shear induced gripping and prevent micro-slippage of the tire 10 at the rim interface. A nanostructure interface for the toeguard/chafer, or nanoskin 801, may achieve shear induced gripping to prevent micro-slippage of the tire 10 at the rim interface and may stabilize the force distribution on the rim flange 14 leading to reducing steering performance loss.

While the present invention has been specifically illustrated and described, those skilled in the art will recognize that the present invention may be variously modified and practiced without departing from the spirit of the present invention. The present invention is limited only by the scope of the following claims.

1. A pneumatic tire comprising a pair of annular beads, at least one carcass ply wrapped around the beads, a tread disposed over the carcass ply in a crown area of the pneumatic tire, and sidewalls disposed radially between the tread and the beads, the pneumatic tire being characterized in that the pneumatic tire is mounted on a rim and a contact area of the pneumatic tire with the rim has carbon nanotubes for reducing micro-slippage between the beads and the rim during rotation of the pneumatic tire under load.

2. The pneumatic tire as set forth in claim 1 wherein the tread is flat with respect to a surface on which the pneumatic tire is in contact.

3. The pneumatic tire as set forth in claim 1 further comprising reinforcement belts interposed between the carcass ply and the tread in the crown area, the reinforcement belts being anchored in a shoulder region of the pneumatic tire thereby providing hinged support for the tread and a decoupling of the tread from the upper sidewall, the shoulder being defined as the intersection of a ply line radius and a tread radius.

4. The pneumatic tire as set forth in claim 1 wherein a rhoₘ is higher on the pneumatic tire than 50% of a section height of the pneumatic tire.

5. The pneumatic tire as set forth in claim 1 wherein a rhoₘ is 55% to 65% of a section height of the pneumatic tire.

6. The pneumatic tire as set forth in claim 1 wherein a shoulder, 50% of a section height, and the bead define points on a circle; and a shoulder radius of the pneumatic tire is smaller than a radius of the circle.

7. The pneumatic tire as set forth in claim 1 wherein a shoulder, 50% of a section height, and the bead define points on a reference circle; and a shoulder radius of the pneumatic tire is 50% to 60% of a radius reference of circle.

8. The pneumatic tire as set forth in claim 1 wherein lower portions of the sidewalls have a concave profile.

9. The pneumatic tire as set forth in claim 1 wherein a molded base width is 20% to 25% wider than a specification rim width for the pneumatic tire.

10. The pneumatic tire as set forth in claim 1 wherein turn-up ply endings extend at least to 35% of a section height of the pneumatic tire.

11. The pneumatic tire as set forth in claim 1 wherein an apex extends at least 20% of a section height of the pneumatic tire.

12. A method for assembling a pneumatic tire onto a rim comprising the step of orienting carbon nanotubes adjacent a contact surface of the rim such that each carbon nanotube extends perpendicularly to its individual contact point on the rim thereby reducing micro-slippage between the pneumatic tire and the rim during rotation of the pneumatic tire under load.
